(19) United States
(12) Patent Application Publication
(10) Pub. No.: US 2016/0257084 A1
(43) Pub. Date: Sep. 8, 2016

(54) Shoe Mold Unit

(71) Applicant: Ming-Te Chen, Taichung (TW)

(72) Inventor: Ming-Te Chen, Taichung (TW)

(21) Appl. No.: 14/636,271

(22) Filed: Mar. 3, 2015

(51) Int. Cl. B29D 35/12; B29C 39/02

(52) U.S. Cl. CPC B29D 35/128; B29C 39/026

(57) ABSTRACT

A shoe mold unit includes a base mold having a shoe molding part on the top thereof and a concavity. A left mold and a right mold are respectively located on two sides of the base mold, and each of the left and right molds has a recessed positioning portion with which a protection member is respectively engaged. Two respective ridges are located on two respective insides of the left mold and the right mold. The ridges protect the outside of the vamp and restrict the space for formation of the outsole such that no surplus material is formed on the outsole and the defective rate is reduced.

### FIELD OF THE INVENTION

The present invention is a divisional application of application's former patent application Ser. No. 13/271,201 filed on Oct. 11, 2011.

### BACKGROUND OF THE INVENTION

A conventional shoe mold unit is shown in FIG. 1 and generally includes a base mold 1 which is in shape of a shoe and a concavity is defined in the top of the base mold 1 and the concavity includes patterns for the outsole, a left mold and a right mold 2 are located on two sides of the base mold 1. A vamp 3 is mounted to the shoe last which is then engaged with the concavity. The left and right molds 2 are moved and contact the two sides of the base mold 1 so as to form a space 4 for the outsole. Material for the outsole is poured into the concavity and cooled, the vamp 3 and the outsole are combined to each other. However, due to lack of precision between the left and right molds 2 and the base mold 1, and the gaps between the left and right molds 2 and the base mold 1, the material is not evenly formed on two sides of the outsole and surplus material is formed and overflows from the concavity. Extra trimming laboring is required. On the other hand, if the left and right molds 2 are made to be precisely matched with the base mold 1, because the stiffness of the molds 1, 2, the vamp 3 is easily scratched and the defective rate is increased.

The present invention intends to provide a shoe mold unit which improves the shortcomings of the conventional shoe mold units.

### SUMMARY OF THE INVENTION

The present invention relates to a shoe mold unit and comprises a base mold with a shoe molding part and a left mold and a right mold are respectively located on two sides of the base mold. Each of the left and right molds has a recessed positioning portion with which a protection member is respectively engaged. Two respective ridges are located on two respective insides of the left mold and the right mold. The ridges protect the outside of the vamp and restrict the space for formation of the outsole such that no surplus material is formed on the outsole and the defective rate is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional shoe mold unit and a shoe in the conventional shoe mold unit;

FIG. 2 is an exploded view to show the shoe mold unit of the present invention for making casual shoes;

FIG. 3 is a cross sectional view to show the shoe mold unit of the present invention for making casual shoes;

FIG. 4 is an exploded view to show the shoe mold unit of the present invention for making sport shoes;

FIG. 5 is a cross sectional view to show the shoe mold unit of the present invention for making sport shoes;

FIG. 6 is an exploded view to show the shoe mold unit of the present invention for making high-heel shoes, and

FIG. 7 is a cross sectional view to show the shoe mold unit of the present invention for making high-heel shoes.

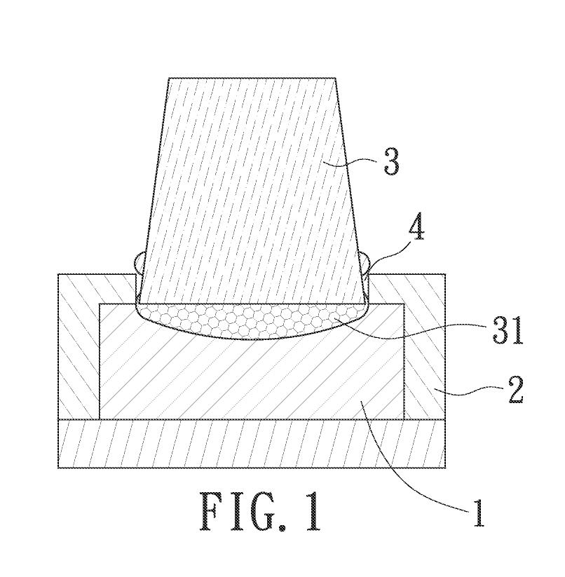

### DETAILED DESCRIPTION OF THE PREFERRED EMBODIMENT

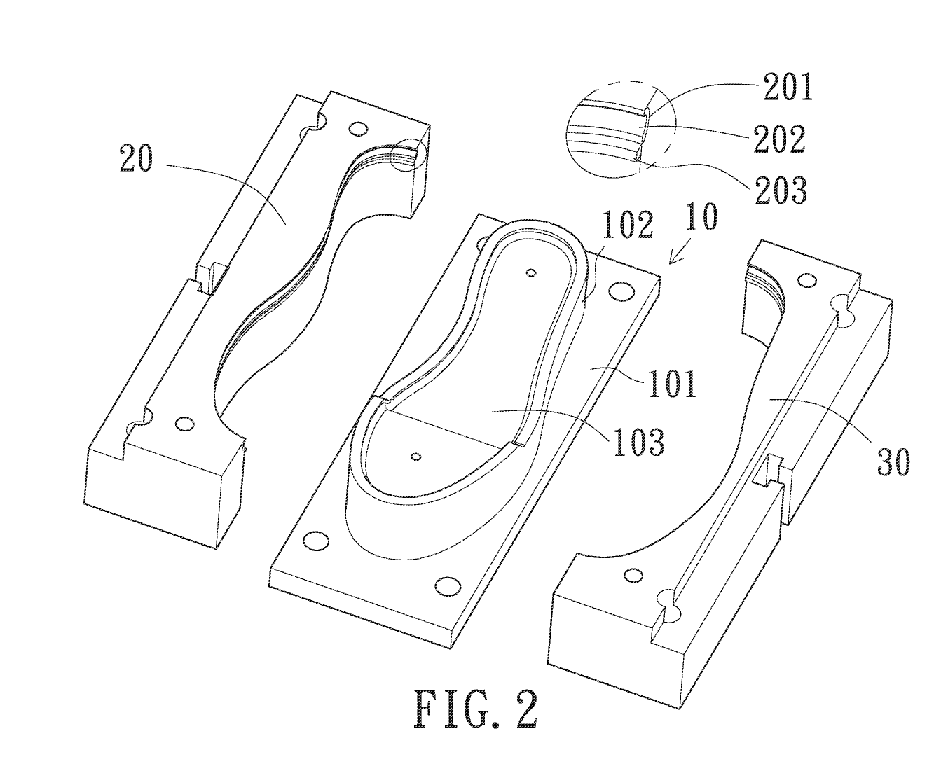

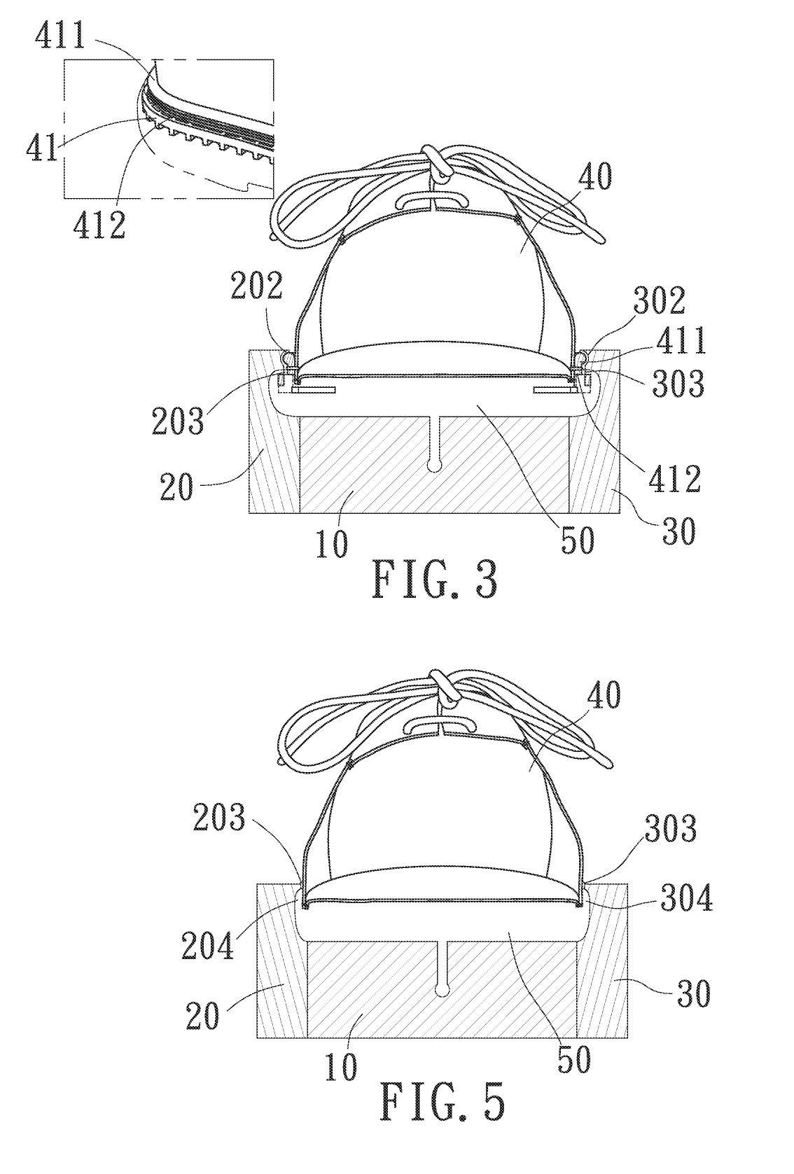

Referring to FIGS. 2 to 3, the shoe mold unit of the present invention comprises a base mold 10 having a shoe molding part 102 on the top 101 thereof and a concavity 103 is defined in the top of the shoe molding part 102.

A left mold 20 and a right mold 30 are respectively located on left side and right side of the base mold 10. Each of the left and right molds 20, 30 has a recessed positioning portion 201/301 defined in the top of the inside thereof. Two respective protection members 202, 302 are respectively engaged with two respective insides of the positioning portions 201, 301 and two respective protection members 202, 203 protrude from two sides of the two respective positioning portions 201, 301. Two respective ridges 203, 303 are located on the two respective insides of the left mold 20 and the right mold 30. The ridges 203, 303 restrict the space for formation of the outsole 50. The protection members 202, 302 and the ridges 203, 303 are made by soft rubber with low density such as silicon metal or silicone.

A vamp 40 is sewed by a peripheral member 41 along the lower edge of the vamp 40. The vamp 40 includes protrusion 411 a recessed portion 412, which is used to position the left mold 20 and the right mold 30 when the material for the outsole 50 is poured in the shoe mold unit. When the outsole 50 is made, the protrusion 411 exposed from the shoe. The vamp 40 is mounted to the shoe last and put into the concavity 103 of the shoe molding part 102 on the top 101 of the base mold 10, and the peripheral member 41 is sewed to the vamp 41, the left mold 20 and the right mold 30 are moved to match with the base mold 10. The positioning portions 201, 301 are engaged with the protrusion 411 of the peripheral member 41, and the protection members 202, 302 are securely matched with the protrusion 411 of the peripheral member 41, so that the protrusion 411 of the peripheral member 41 is not damaged. The ridges 203, 303 are engaged with the recessed portion 412 of the peripheral member 41. Because the ridges 203, 303 are made by soft rubber which is snugly engaged with the recessed portion 412 of the peripheral member 41 so that there will be no gap defined therebetween and the recessed portion 412 is not damaged. Accordingly, the space for the outsole 50 is enclosed and sealed, the material for the outsole 50 is stopped by the ridges 203, 303 and no surplus material is formed. The outsole 50 is formed within one pouring process without need of trimming. The protrusion 411 and the recessed portion 412 of the peripheral member 41 are protected.

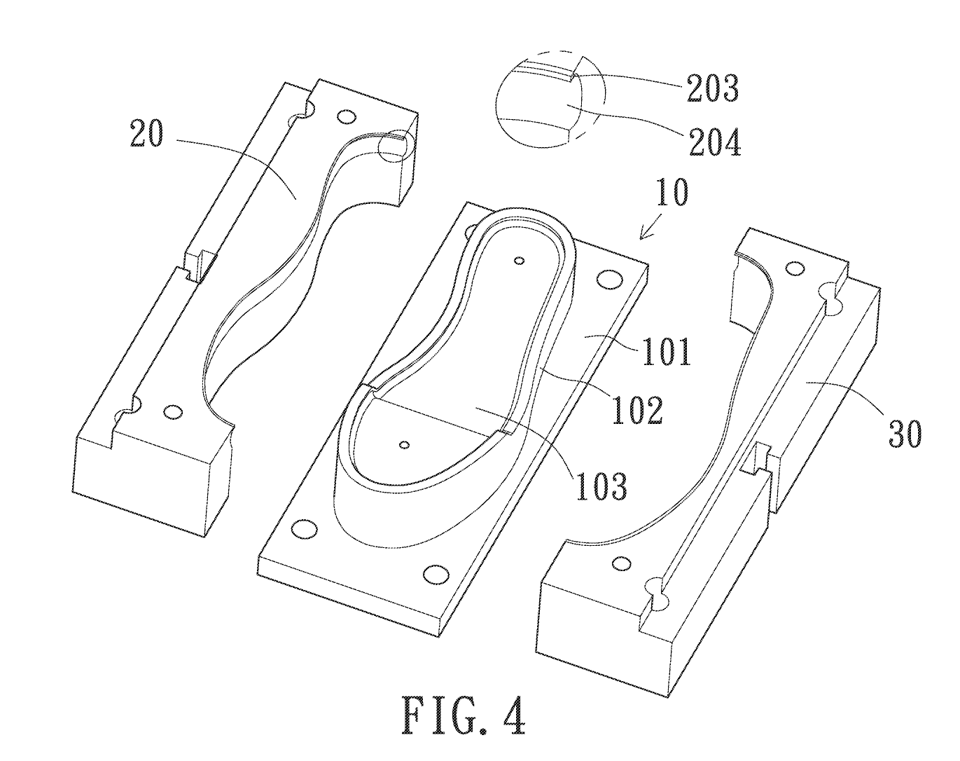

Referring to FIGS. 4 and 5, which show the shoe mold unit is used to manufacture sport shoes which do not have peripheral member 41 on the vamp 40. The outsole 50 is directly formed to the underside of the vamp 40. Each of the left and right molds 20, 30 has a formation portion 204/304 formed on the top of inside thereof. The vamp 40 is mounted to the shoe last and put into the concavity 103 of the shoe molding part 102 on the top 101 of the base mold 10, and the left mold 20 and the right mold 30 are moved to match with the base mold 10. The ridges 203, 303 are in contact a position of the vamp 40 where the top edge of the outsole 50 is formed. Because the ridges 203, 303 are made by soft rubber which is snugly in contact with the vamp 40 so that there will be no gap defined therebetween and the vamp 40 is not damaged. Accordingly, the space for the outsole 50 is enclosed and sealed, the material for the outsole 50 is stopped by the ridges 203, 303 and no surplus material is formed. The outsole 50 is formed within one pouring process without need of trimming and the vamp 40 is well protected.

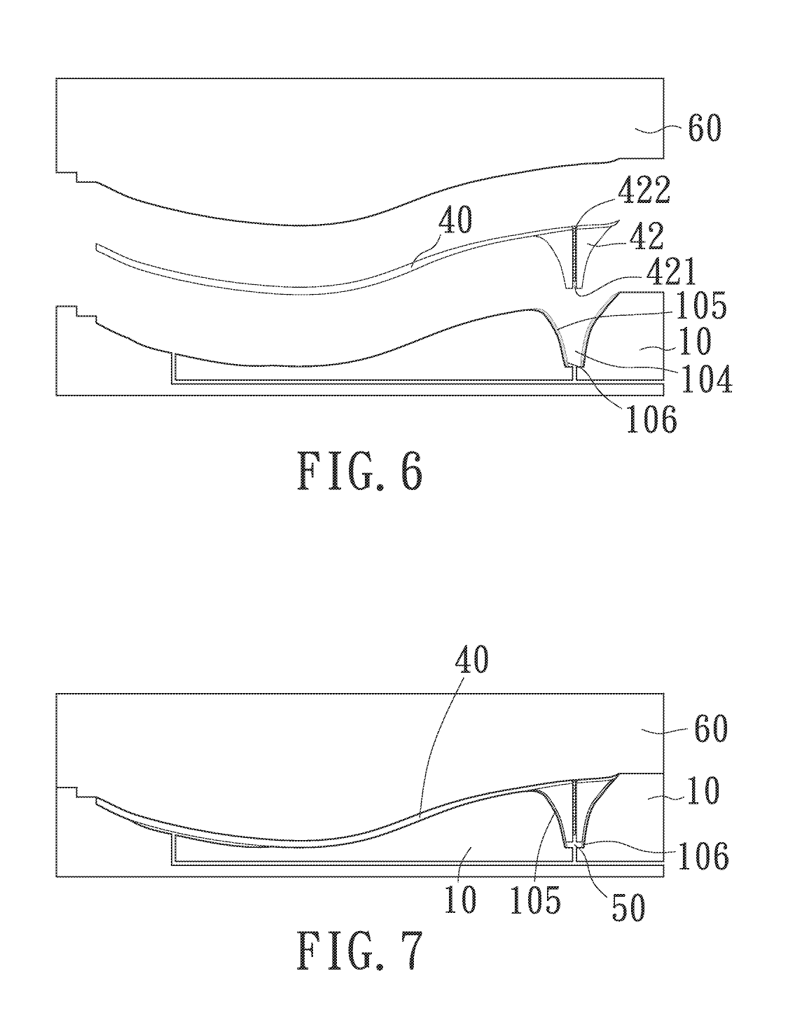

Referring to FIGS. 6 and 7, 5, which show the shoe mold unit is used to manufacture high-heel shoes. The heel 42 includes a hollow portion 421 defined therein and a bolt 422 is used to fix the heel 42 and the vamp 40. The combination of the vamp 40 and the heel 42 is put in the concavity 104 of the base mold 10.

A first protection portion 105 and a second protection portion 106 are located at the inside of the concavity 104, wherein the second protection portion 106 is located beneath of the first protection portion 105. The first protection portion 105 protects the outside of the heel 42 and makes the heel 42 be securely matched with the concavity 104.

The second protection portion 106 is located beneath the first protection portion 105 so as to form the outsole 50. The first and second protection portions 105, 106 are made by soft rubber with low density, such as silicon metal or silicone. Before the heel 42 is not yet put in the concavity 104, the thickness of the first protection portion 105 is thicker than that of the second protection portion 106. After the heel 42 is put in the concavity 104, the first protection portion 105 and the second protection portion 106 have the same thickness.

When pouring material into the concavity 104 to form the outsole 50, the combination of the vamp 40 and the heel 42 is put in the concavity 104 of the base mold 10, the top mold 60 is matched to the base mold 10 from the top of the base mold 10. Because there is no gap between the heel 42 and the first protection portion 105, so that the space for the outsole 50 is enclosed and sealed. When the material for the outsole 50 is introduced into the space, the outsole 50 is formed in the space between the underside of the heel 42 and the area corresponding to the second protection portion 106. No surplus material is formed. Besides, because the pressure when pouring the material, the material is filled in the hollow portion 421 to securely connect the vamp 40 and the heel 42.

The shoe mold unit of the present invention improves the shortcomings of the conventional shoe mold unit and the outsole can be made within one process without need of trimming.

While we have shown and described the embodiment in accordance with the present invention, it should be clear to those skilled in the art that further embodiments may be made without departing from the scope of the present invention.

What is claimed is:

1. A shoe mold unit comprising:
a base mold having a shoe molding part on a top thereof and a concavity defined in a top of the shoe molding part;
a left mold and a right mold respectively located on left side and right side of the base mold, each of the left and right molds having a recessed positioning portion, two respective protection members respectively engaged with two respective insides of the positioning portions and adapted to protect a vamp in the concavity;
two respective ridges located on two respective insides of the left mold and the right mold, the ridges restricting a space for formation of an outsole.

2. The shoe mold unit as claimed in claim 1, wherein the two respective protection members protrude from two sides of the two respective positioning portions.

3. The shoe mold unit as claimed in claim 1, wherein the protection members and the ridges are made by soft rubber with low density.

4. A shoe mold unit comprising:
a base mold having a shoe molding part on a top thereof and a concavity defined in a top of the shoe molding part;
a left mold and a right mold respectively located on left side and right side of the base mold, each of the left and right molds having a formation portion formed on a top of inside thereof;
two respective ridges located above the two formation portions, the ridges restricting a space for formation of an outsole.

5. The shoe molding unit as claimed in claim 4, wherein the wherein the protection members and the ridges are made by soft rubber with low density.

6. A shoe mold unit comprising:
a base mold having a concavity defined therein for receiving material for outsole;
a first protection portion located at an inside of the concavity and securely combined with a heel in the concavity, the first protection portion restricting a space for formation of an outsole;
a second protection portion located beneath the first protection portion and at the inside of the concavity so as to be adapted to form an outsole.

7. The shoe mold unit as claimed in claim 6, wherein the first protection portion is made by soft rubber with low density.

8. The shoe mold unit as claimed in claim 6, wherein the second protection portion is made by soft rubber with low density.

9. The shoe mold unit as claimed in claim 6, wherein a thickness of the first protection portion is thicker than that of the second protection portion, the first protection portion and the second protection portion have the same thickness when a heel is installed.
